(19) United States
(12) Patent Application Publication
(10) Pub. No.: US 2026/0202893 A1
(43) Pub. Date: Jul. 16, 2026

(54) POWER SUPPLY CIRCUIT

(71) Applicant: ASUSTeK COMPUTER INC., Taipei City (TW)

(72) Inventors: Wei-Gen Chung, Taipei City (TW); Hsiang-Jui Hung, Taipei City (TW); Hsi-Ho Hsu, Taipei City (TW); Chun-San Lin, Taipei City (TW); Wei Kao, Taipei City (TW); Yu-Kai Yeh, Taipei City (TW); Chang-Tsai Tsai, Taipei City (TW)

(73) Assignee: ASUSTeK COMPUTER INC., Taipei City (TW)

(21) Appl. No.: 19/438,658

(22) Filed: Jan. 2, 2026

(30) Foreign Application Priority Data
Jan. 13, 2025 (TW) 114101359

(51) Int. Cl. G06F 1/26

(52) U.S. Cl. CPC G06F 1/263

(57) ABSTRACT

Disclosed is a power supply circuit adapted to an electronic device. The power supply circuit includes a first interface terminal, a second interface terminal, a resistor circuit, a charge and discharge circuit and a plurality of switch circuits. The first interface terminal receives a first power voltage. The second interface terminal receives a second power voltage. The charge and discharge circuit detects a voltage generated between a first detection point and a second detection point in the resistor circuit. The switch circuits are respectively coupled between the first interface terminal and the resistor circuit and between the second interface terminal and the resistor circuit, and controlled by a plurality of control signals to be turned on or off, thereby changing a position of the first detection point based on whether a power source of the electronic device is from the first interface terminal or the second interface terminal.

### CROSS-REFERENCE TO RELATED APPLICATION

This application claims the priority benefit of Taiwan application serial no. 114101359, filed on January 13, 2025. The entirety of the above-mentioned patent application is hereby incorporated by reference herein and made a part of this specification.

### BACKGROUND

### Technical Field

The present disclosure relates to a power supply circuit capable of dynamically changing a current sensing resistor.

### Description of Related Art

Contemporary electronic devices emphasizing high performance (e.g., gaming laptops) are typically equipped with AC adapters rated at approximately 200 watts or higher. Additionally, to accommodate users who primarily require word processing capabilities, these electronic devices are often furnished with charging ports that support USB Type-C Power Delivery (PD). Consequently, a power supply circuit architecture capable of accommodating both aforementioned power delivery methods is necessitated. However, the design presents challenges not only in terms of excessive spatial requirements but also with respect to current-carrying capacity and current sensing accuracy. Specifically, to prevent voltage generated across the current sensing resistor from exceeding safety thresholds during AC adapter power delivery, thereby averting current-carrying capacity issues, a current sensing resistor with a lower resistance value is employed. Nevertheless, the utilization of such a low-resistance current sensing resistor in conjunction with USB Type-C PD power delivery might result in insufficient current sensing accuracy.

### SUMMARY

The present disclosure provides a power supply circuit adaptable for an electronic device. This power supply circuit includes a first interface terminal, a second interface terminal, a resistor circuit, a charge and discharge circuit, and multiple switch circuits. The first interface terminal is configured to receive a first power voltage. The second interface terminal is configured to receive a second power voltage. The charge and discharge circuit is coupled to the resistor circuit and configured to detect a voltage generated between a first detection point and a second detection point in the resistor circuit. The switch circuits are respectively coupled between the first interface terminal and the resistor circuit, and between the second interface terminal and the resistor circuit, and configured to be controlled by multiple control signals to be turned on or off, thereby changing the position of the first detection point according to whether a power source of the electronic device is from the first interface terminal or the second interface terminal.

Based on the above, the power supply circuit of the present disclosure may dynamically change the resistance value of the current sensing resistor according to the types of power source. As a result, the power supply circuit may be implemented with limited circuit space, which not only reduces the occupied area and manufacturing cost, but also simultaneously addresses the problems of current-carrying capacity and current sensing accuracy.

To make the above features and advantages of the present disclosure more comprehensible, exemplary embodiments are described below with reference to the accompanying drawings in detail as follows.

### BRIEF DESCRIPTION OF THE DRAWINGS

FIG. 1 is a block diagram illustrating a power supply circuit according to an embodiment of the present disclosure.

FIG. 2 is a circuit diagram illustrating a power supply circuit according to an embodiment of the present disclosure.

FIG. 3A and FIG. 3B are operational diagrams illustrating a power supply circuit according to an embodiment of the present disclosure.

FIG. 4 is a circuit diagram illustrating a power supply circuit according to another embodiment of the present disclosure.

### DESCRIPTION OF THE EMBODIMENTS

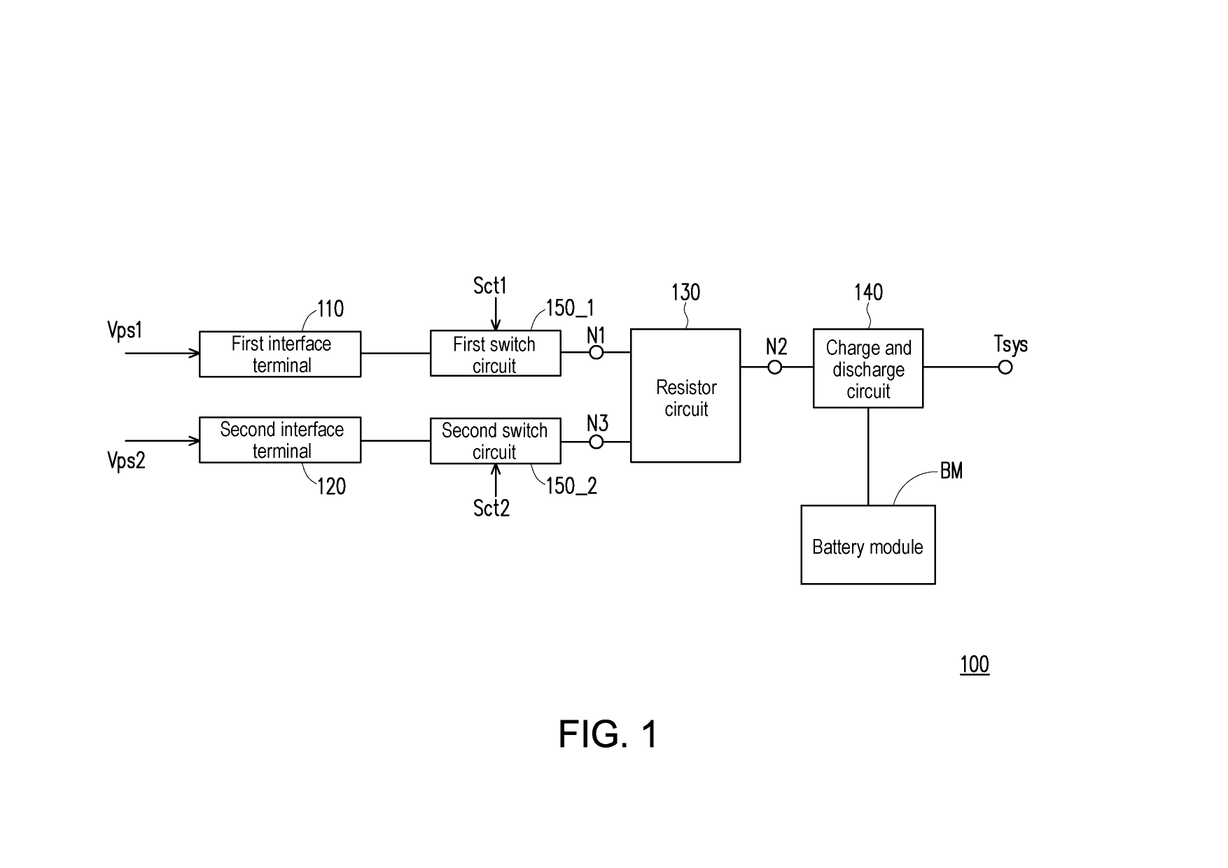

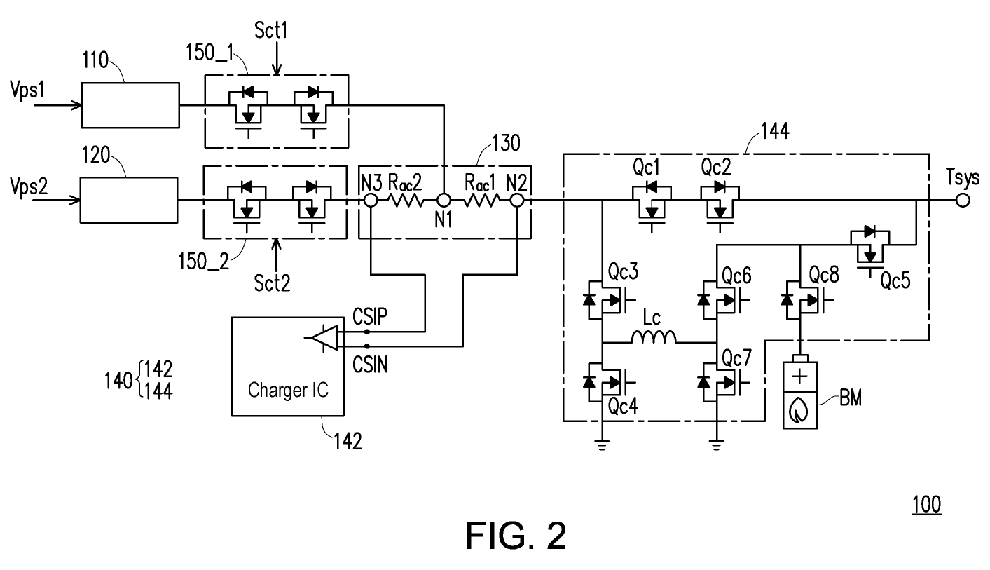

Please refer to FIG. 1 and FIG. 2 simultaneously. The power supply circuit 100 of this embodiment is applicable to electronic devices such as notebook computers, mobile phones, and tablet computers, which are handheld electronic products. The power supply circuit 100 includes a first interface terminal 110, a second interface terminal 120, a resistor circuit 130, a charge and discharge circuit 140, a first switch circuit 150_1, and a second switch circuit 150_2.

In one embodiment, the first interface terminal 110 is plugged in by a first power adapter, such as an alternating current adapter, which is not limited herein. The first interface terminal 110 is configured to receive a first power voltage Vps1 from the first power adapter.

In one embodiment, the second interface terminal 120 is plugged in b a second power adapter, such as a PD adapter (supplying power using USB Type-C PD method), which is not limited herein. The second interface terminal 120 is configured to receive a second power voltage Vps2 from the second power adapter.

The resistor circuit 130 includes a first resistor Rac1 and a second resistor Rac2. The first resistor Rac1 is coupled between a first node N1 and a second node N2. The second resistor Rac2 is coupled between the first node N1 and a third node N3. The resistance value of the first resistor Rac1 may be equal to the resistance value of the second resistor Rac2 (for example, 5 mΩ), but the present disclosure is not limited herein.

The charge and discharge circuit 140 is coupled to the resistor circuit 130. The charge and discharge circuit 140 may detect the voltage generated between the first detection point PS1 and the second detection point PS2 in the resistor circuit 130. Specifically, as shown in FIG. 2, the charge and discharge circuit 140 includes a charger IC 142 and a charge and discharge component set 144. The first input terminal CSIN of the charger IC 142 is coupled to the second node N2, and the second input terminal CSIP of the charger IC 142 is coupled to the third node N3. In this embodiment, the second detection point PS2 is disposed at the second node N2. The first detection point PS1 may be switched between the first node N1 and the third node N3. The charger IC 142 may detect the voltage generated across the current sensing resistor Rsense formed between the first detection point PS1 and the second detection point PS2.

The charge and discharge component set 144 is coupled to the second node N2 (second detection point PS2), a battery module BM of the electronic device, and a system power terminal Tsys. The battery module BM may be an embedded or external battery module, including a battery cell set and a control circuit. In one embodiment, the battery cell set is composed of a single or multiple battery cells (individual battery cells), which is not limited herein. In one embodiment, the control circuit is a battery gauge IC or a microcontroller, which is not limited herein. In one embodiment, the charge and discharge component set 144 powers the system power terminal Tsys from the second node N2 (second detection point PS2) or the battery module BM and then the system power terminal Tsys transmits power through a voltage regulator to a Central Processing Unit (CPU), a Graphics Processing Unit (GPU), and various system components on the motherboard, which is not limited here.

In FIG. 2, the charge and discharge component set 144 includes a first charge and discharge component Qc1, a second charge and discharge component Qc2, a third charge and discharge component Qc3, a fourth charge and discharge component Qc4, a fifth charge and discharge component Qc5, a sixth charge and discharge component Qc6, a seventh charge and discharge component Qc7, an eighth charge and discharge component Qc8, and a ninth charge and discharge component Lc. The first terminal of the first charge and discharge component Qc1 is coupled to the second node N2 (second detection point PS2). The first terminal of the second charge and discharge component Qc2 is coupled to the second terminal of the first charge and discharge component Qc1, and the second terminal of the second charge and discharge component Qc2 is coupled to the system power terminal Tsys. The first terminal of the third charge and discharge component Qc3 is coupled to the second node N2 (second detection point PS2). The first terminal of the fourth charge and discharge component Qc4 is coupled to the second terminal of the third charge and discharge component Qc3, and the second terminal of the fourth charge and discharge component Qc4 is grounded. The first terminal of the fifth charge and discharge component Qc5 is coupled to the system power terminal Tsys. The first terminal of the sixth charge and discharge component Qc6 is coupled to the second terminal of the fifth charge and discharge component Qc5. The first terminal of the seventh charge and discharge component Qc7 is coupled to the second terminal of the sixth charge and discharge component Qc6, and the second terminal of the seventh charge and discharge component Qc7 is grounded. The first terminal of the eighth charge and discharge component Qc8 is coupled to the second terminal of the fifth charge and discharge component Qc5, and the second terminal of the eighth charge and discharge component Qc8 is coupled to the battery module BM. The first terminal of the ninth charge and discharge component Lc is coupled to the second terminal of the third charge and discharge component Qc3, and the second terminal of the ninth charge and discharge component Lc is coupled to the second terminal of the sixth charge and discharge component Qc6. The charger IC 142 may control the on and off of each component in the charge and discharge component set 144 according to the voltage generated across the current sensing resistor Rsense formed between the first detection point PS1 and the second detection point PS2, to appropriately adjust the current path and the current flowing through the charge and discharge component set 144. Additionally, the charge and discharge component set 144 may also switch paths based on whether the power supplied to the system power terminal Tsys is sufficient. When the power is sufficient, the battery module BM is charged, and when the power is insufficient, the path is switched to use the battery module BM for supplying power.

The first switch circuit 150_1 is coupled between the first interface terminal 110 and the first node N1, and may be controlled to be turned on or off by the control signal Sct1. The second switch circuit 150_2 is coupled between the second interface terminal 120 and the third node N3, and may be controlled to be turned on or off by the control signal Sct2. The control signal Sct1 and the control signal Sct2 may be provided by a controller in the electronic device (for example, an embedded controller (EC) or a microcontroller). For instance, the controller in the electronic device may determine whether the power source of the electronic device is from the first interface terminal 110 or the second interface terminal 120. When the first power adapter is plugged into the first interface terminal 110, the controller determines that the power source is from the first interface terminal 110. When the second power adapter is plugged into the second interface terminal 120, the controller determines that the power source is from the second interface terminal 120.

The controller may provide the control signal Sct1 and the control signal Sct2 to the first switch circuit 150_1 and the second switch circuit 150_2, respectively, based on the power supply determination result, thereby changing the position of the first detection point PS1 according to whether the power source of the electronic device is from the first interface terminal 110 or the second interface terminal 120.

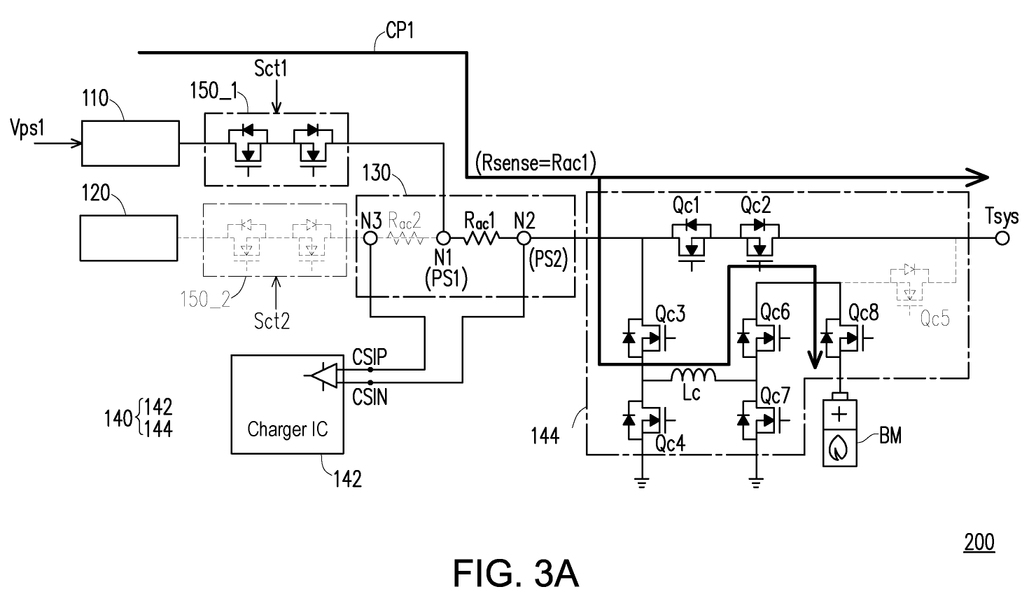

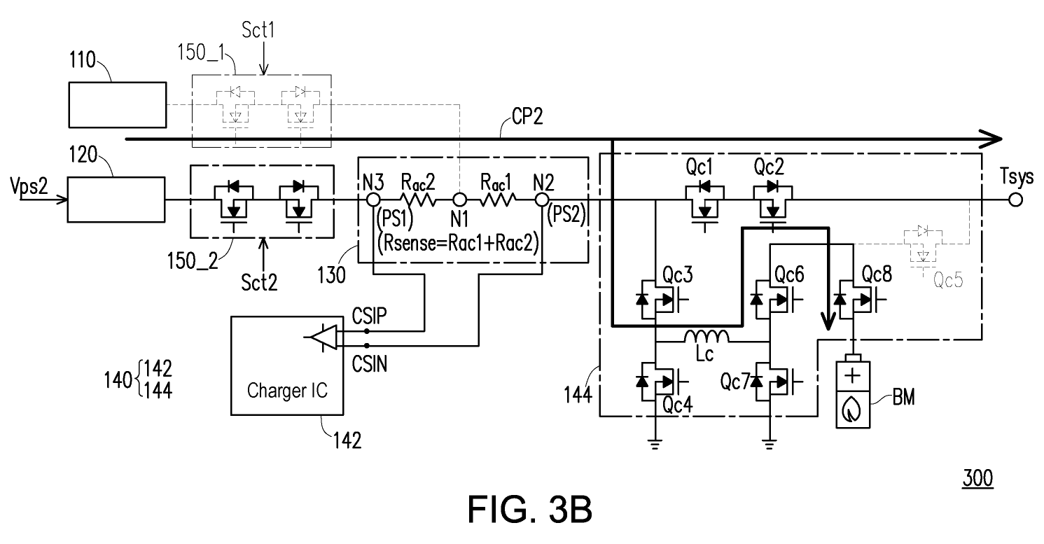

Specifically, the first switch circuit 150_1 and the second switch circuit 150_2 may set the first node N1 or the third node N3 as the first detection point PS1 according to whether the power source of the electronic device is from the first interface terminal 110 or the second interface terminal 120. When the power source is from the first interface terminal 110, the first switch circuit 150_1 is controlled to be turned on by the control signal Sct1 of a high logic level, while the second switch circuit 150_2 is controlled to be turned off by the control signal Sct2 of at a low logic level. Under the circumstances, as shown in FIG. 3A, the current path CP1 from the first interface terminal 110 only passes through the first resistor Rac1. Since the second switch circuit 150_2 is turned off, no current flows through the second resistor Rac2, and the voltage generated across the second resistor Rac2 is 0, so the second resistor Rac2 is considered as a short circuit. Therefore, the first detection point PS1 is equivalent to the first node N1 (i.e., the first detection point PS1 is switched to the first node N1), and the current sensing resistor Rsense is equivalent to the first resistor Rac1 (Rsense=Rac1).

When the power source is from the second interface terminal 120, the first switch circuit 150_1 is controlled to be turned off by the control signal Sct1 of a low logic level, while the second switch circuit 150_2 is controlled to be turned on by the control signal Sct2 of a high logic level. Under the circumstances, as shown in FIG. 3B, the current path CP2 from the second interface terminal 120 passes through both the first resistor Rac1 and the second resistor Rac2. Since the first switch circuit 150_1 is turned off, all current flows through the first resistor Rac1 and the second resistor Rac2. Therefore, the first detection point PS1 is equivalent to the third node N3 (i.e., the first detection point PS1 is switched to the third node N3), and the current sensing resistor Rsense is equivalent to the sum of the first resistor Rac1 and the second resistor Rac2 (Rsense=Rac1+Rac2).

Through the above operations, the power supply circuit 100 may dynamically change the resistance value of the current sensing resistor Rsense according to the types of power source. When the power source is from the AC adapter at the first interface terminal 110, the resistance value of the current sensing resistor Rsense is reduced to avoid the problem of current-carrying capacity caused by voltage exceeding the safe range. When the power source is from the PD adapter at the second interface terminal 120, the resistance value of the current sensing resistor Rsense is increased to prevent the problem of insufficient current sensing accuracy. In this way, it is possible to address both the current-carrying capacity and current sensing accuracy problems within a limited circuit space.

The first switch circuit 150_1, the second switch circuit 150_2, and the first to eighth charge and discharge components Qc1 to Qc8 are, for example, implemented using N-type Metal-Oxide-Semiconductor Field-Effect Transistors (NMOSFETs), but the present disclosure is not limited to this. In other embodiments, they may also be implemented using P-type Metal-Oxide-Semiconductor Field-Effect Transistors (PMOSFETs).

In addition, in an embodiment, when the first power adapter is plugged into the first interface terminal 110 and simultaneously the second power adapter is plugged into the second interface terminal 120, it may be regarded as the power source coming from the first interface terminal 110, and the operation may be conducted using the corresponding power supply method as described above. However, the present disclosure is not limited to this.

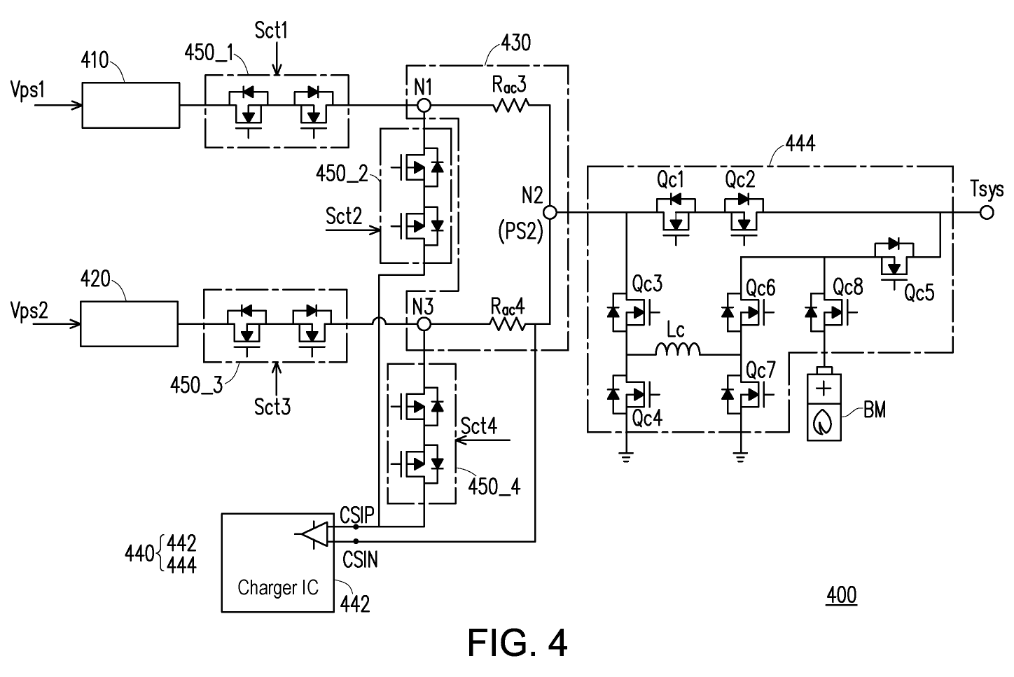

The following describes another embodiment of the power supply circuit. Please refer to FIG. 4, the power supply circuit 400 includes a first interface terminal 410, a second interface terminal 420, a resistor circuit 430, a charge and discharge circuit 440, a first switch circuit 450_1, a second switch circuit 450_2, a third switch circuit 450_3, and a fourth switch circuit 450_4.

The first interface terminal 410 is configured to receive a first power voltage Vps1 from a first power adapter. The second interface terminal 420 is configured to receive a second power voltage Vps2 from a second power adapter.

The resistor circuit 430 includes a third resistor Rac3 and a fourth resistor Rac4. The third resistor Rac3 is coupled between the first node N1 and the second node N2. The fourth resistor Rac4 is coupled between the third node N3 and the second node N2. The resistance value of the fourth resistor Rac4 (for example, 10 mΩ) is greater than the resistance value of the third resistor Rac3 (for example, 5 mΩ).

The charge and discharge circuit 440 is coupled to the resistor circuit 430. The charge and discharge circuit 440 includes a charger IC 442 and a charge and discharge component set 444. The first input terminal CSIN of the charger IC 442 is coupled to the second node N2, and the second input terminal CSIP of the charger IC 442 is coupled to the first node N1 and the third node N3 through the second switch circuit 450_2 and the fourth switch circuit 450_4, respectively. Similarly, in this embodiment, the second detection point PS2 is disposed at the second node N2. The first detection point PS1 may be switched between the first node N1 and the third node N3. The charger IC 442 may detect the voltage generated across the current sensing resistor Rsense formed between the first detection point PS1 and the second detection point PS2.

The charge and discharge component set 444 is coupled to the second node N2 (the second detection point PS2), the battery module BM of the electronic device, and the system power terminal Tsys. The charge and discharge component set 444 in this embodiment is the same as or similar to the charge and discharge circuit 140 in the previous embodiment, so the implementation details and operation method thereof will not be repeated here.

The first switch circuit 450_1 is coupled between the first interface terminal 410 and the first node N1, and may be controlled to be turned on or off by the control signal Sct1. The second switch circuit 450_2 is coupled between the first node N1 and the second input terminal CSIP of the charger IC 442, and may be controlled to be turned on or off by the control signal Sct2. The third switch circuit 450_3 is coupled between the second interface terminal 420 and the third node N3, and may be controlled to be turned on or off by the control signal Sct3. The fourth switch circuit 450_4 is coupled between the third node N3 and the second input terminal CSIP of the charger IC 442, and may be controlled to be turned on or off by the control signal Sct4. The control signals Sct1 to Sct4 may be provided by a controller in the electronic device.

The controller may provide control signals Sct1 to Sct4 to the first switch circuit 450_1 to the fourth switch circuit 450_4 respectively according to the power supply determination result, thereby changing the position of the first detection point PS1 based on whether the power source of the electronic device is from the first interface terminal 410 or the second interface terminal 420.

Specifically, the first switch circuit 450_1 to the fourth switch circuit 450_4 may set the first node N1 or the third node N3 as the first detection point PS1 based on whether the power source of the electronic device is from the first interface terminal 410 or the second interface terminal 420. When the power source is from the first interface terminal 410, the first switch circuit 450_1 and the second switch circuit 450_2 are controlled to be turned on by control signals Sct1 and Sct2 of high logic level respectively, while the third switch circuit 450_3 and the fourth switch circuit 450_4 are controlled to be turned off by control signals Sct3 and Sct4 of low logic level respectively. Under the circumstances, the current path from the first interface terminal 410 will only pass through the third resistor Rac3. Since the third switch circuit 450_3 and the fourth switch circuit 450_4 are turned off, no current flows through the fourth resistor Rac4. Therefore, the first detection point PS1 is equivalent to the first node N1 (i.e., the first detection point PS1 is switched to the first node N1), and the current sensing resistor Rsense is equivalent to the third resistor Rac3 (Rsense=Rac3).

When the power source is from the second interface terminal 420, the first switch circuit 450_1 and the second switch circuit 450_2 are controlled to be turned off by control signals Sct1 and Sct2 of low logic level respectively, while the third switch circuit 450_3 and the fourth switch circuit 450_4 are controlled to be turned on by control signals Sct3 and Sct4 of high logic level respectively. Under the circumstances, the current path from the second interface terminal 420 will only pass through the fourth resistor Rac4. Since the first switch circuit 450_1 and the second switch circuit 450_2 are turned off, no current flows through the third resistor Rac3. Therefore, the first detection point PS1 is equivalent to the third node N3 (i.e., the first detection point PS1 is switched to the third node N3), and the current sensing resistor Rsense is equivalent to the fourth resistor Rac4 (Rsense=Rac4).

In summary, the power supply circuit of this disclosure may dynamically change the resistance value of the current sensing resistor according to the types of power source. When the power source is from an AC adapter, the resistance value of the current sensing resistor is reduced to avoid the problem of current-carrying capacity caused by voltage exceeding the safe range. When the power source is from a PD adapter, the resistance value of the current sensing resistor is increased to prevent the problem of insufficient current sensing accuracy. As a result, the power supply circuit may be implemented with limited circuit space, which not only reduces the occupied area and manufacturing cost, but also addresses both the current-carrying capacity and current sensing accuracy problems simultaneously.

What is claimed is:

1. A power supply circuit adaptable for an electronic device, the power supply circuit comprising:
a first interface terminal, configured to receive a first power voltage;
a second interface terminal, configured to receive a second power voltage;
a resistor circuit;
a charge and discharge circuit, coupled to the resistor circuit and configured to detect a voltage generated between a first detection point and a second detection point in the resistor circuit; and
a plurality of switch circuits, respectively coupled between the first interface terminal and the resistor circuit, and between the second interface terminal and the resistor circuit, and configured to be controlled by a plurality of control signals to be turned on or off, thereby changing a position of the first detection point according to whether a power source of the electronic device is from the first interface terminal or the second interface terminal.

2. The power supply circuit according to claim 1, wherein the first interface terminal receives the first power voltage from a first power adapter, and the second interface terminal receives the second power voltage from a second power adapter.

3. The power supply circuit according to claim 1, wherein a controller in the electronic device determines whether the power source is from the first interface terminal or the second interface terminal, and accordingly provides the plurality of control signals to the plurality of switch circuits respectively.

4. The power supply circuit according to claim 3, wherein when a first power adapter is plugged into the first interface terminal, the controller determines that the power source is from the first interface terminal, and when a second power adapter is plugged into the second interface terminal, the controller determines that the power source is from the second interface terminal.

5. The power supply circuit according to claim 1, wherein the resistor circuit comprises:
a first resistor, coupled between a first node and a second node; and
a second resistor, coupled between the first node and a third node,
wherein the second detection point is disposed at the second node,
the plurality of switch circuits set the first node or the third node as the first detection point according to whether the power source of the electronic device is from the first interface terminal or the second interface terminal.

6. The power supply circuit according to claim 5, wherein the charge and discharge circuit comprises a charger IC, a first input terminal of the charger IC is coupled to the second node, a second input terminal of the charger IC is coupled to the third node,
the plurality of switch circuits comprising:
a first switch circuit, coupled between the first interface terminal and the first node; and
a second switch circuit, coupled between the second interface terminal and the third node.

7. The power supply circuit according to claim 6, wherein when the power source is from the first interface terminal, the first switch circuit is controlled by a first control signal to be turned on, and the second switch circuit is controlled by a second control signal to be turned off,
when the power source is from the second interface terminal, the first switch circuit is controlled by the first control signal to be turned off, and the second switch circuit is controlled by the second control signal to be turned on.

8. The power supply circuit according to claim 1, wherein the resistor circuit comprises:
a third resistor, coupled between a first node and a second node; and
a fourth resistor, coupled between a third node and the second node, wherein a resistance value of the fourth resistor is greater than a resistance value of the third resistor,
wherein the second detection point is disposed at the second node,
the plurality of switch circuits set the first node or the third node as the first detection point according to whether the power source of the electronic device is from the first interface terminal or the second interface terminal.

9. The power supply circuit according to claim 8, wherein the charge and discharge circuit comprises a charger IC, a first input terminal of the charger IC is coupled to the second node,
the plurality of switch circuits comprising:
a first switch circuit, coupled between the first interface terminal and the first node;
a second switch circuit, coupled between the first node and a second input terminal of the charger IC;
a third switch circuit, coupled between the second interface terminal and the third node; and
a fourth switch circuit, coupled between the third node and the second input terminal of the charger IC.

10. The power supply circuit according to claim 9, wherein when the power source is from the first interface terminal, the first switch circuit and the second switch circuit are respectively controlled by a first control signal and a second control signal to be turned on, the third switch circuit and the fourth switch circuit are respectively controlled by a third control signal and a fourth control signal to be turned off,
when the power source is from the second interface terminal, the first switch circuit and the second switch circuit are respectively controlled by the first control signal and the second control signal to be turned off, the third switch circuit and the fourth switch circuit are respectively controlled by the third control signal and the fourth control signal to be turned on.

11. The power supply circuit according to claim 1, the charge and discharge circuit comprises:
a charger IC, configured to detect a voltage generated across a current sensing resistor formed between the first detection point and the second detection point; and
a charge and discharge component set, coupled to the second detection point, a battery module of the electronic device and a system power terminal, and configured to power the system power terminal from the second detection point or the battery module.

12. The power supply circuit according to claim 11, wherein the charger IC controls the charge and discharge component set according to the voltage generated across the current sensing resistor to adjust a current flowing through the charge and discharge component set.

13. The power supply circuit according to claim 11, wherein the charge and discharge component set comprises:
a first charge and discharge component, having a first terminal coupled to the second detection point;
a second charge and discharge component, having a first terminal coupled to a second terminal of the first charge and discharge component, and having a second terminal coupled to the system power terminal;
a third charge and discharge component, having a first terminal coupled to the second detection point;
a fourth charge and discharge component, having a first terminal coupled to a second terminal of the third charge and discharge component, and having a second terminal grounded;
a fifth charge and discharge component, having a first terminal coupled to the system power terminal;
a sixth charge and discharge component, having a first terminal coupled to a second terminal of the fifth charge and discharge component;
a seventh charge and discharge component, having a first terminal coupled to a second terminal of the sixth charge and discharge component, and having a second terminal grounded;
an eighth charge and discharge component, having a first terminal coupled to the second terminal of the fifth charge and discharge component, and having a second terminal coupled to the battery module; and
a ninth charge and discharge component, having a first terminal coupled to the second terminal of the third charge and discharge component, and having a second terminal coupled to the second terminal of the sixth charge and discharge component.
